(19) United States
(12) Patent Application Publication
(10) Pub. No.: US 2004/0118452 A1
(43) Pub. Date: Jun. 24, 2004

(54) Apparatus and method for emitting cesium vapor

(75) Inventors: Minho Sohn, Glen Rock, NJ (US); Dae-Il Kim, Riverdale, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Corporation

(21) Appl. No.: 10/661,778

(22) Filed: Sep. 15, 2003

Related U.S. Application Data
(63) Continuation-in-part of application No. 10/058,340, filed on Jan. 30, 2002.

(51) Int. Cl. F16L 53/00; F16K 49/00; F17D 1/18; F17D 1/16

(52) U.S. Cl. 137/13; 137/334

(57) ABSTRACT

The specification and drawings describe and show embodiments of the present invention of an apparatus and method for emitting a cesium vapor. More specifically, the cesium vapor emitter of the present invention includes a housing having at least one chamber therein in fluid communication with at least one outlet, a reservoir containing cesium disposed in the chamber, a filter located between the cesium and the outlet, and a stopper securing the cesium reservoir in the chamber, so that the cesium vapor is emitted through the outlet.

This Application claims priority under 35 U.S.C. § 120 as a continuation-in-part of U.S. application Ser. No. 10/058,340, filed Jan. 30, 2002, which is incorporated in its entirety herein by reference.

### BACKGROUND OF THE INVENTION

1. Field of the Invention

The present invention relates to an apparatus for producing negative ions in a thin film deposition process, and more particularly, to an apparatus for and method of emitting cesium vapor. Although the present invention is suitable for a wide scope of applications, it is particularly suitable for introducing a cesium dose in a precise and reliable way.

2. Discussion of the Related Art

It is well known that a coating of low electron affinity elements on any metal surface reduces the work function of the surface of the substrate, so that the population of electrons at the surface is enhanced by the presence of such an element. Among the low electron affinity elements, cesium (Cs) is the most efficient since it has the lowest electron affinity. Accordingly, cesium has been the most popular element in this regard.

Cesium sources have been developed for an ion beam deposition system, an electron tube for a display or camera tube, an electro-lithographic application, an electron microscopy, or any other photoelectron generator such as mass spectrometry and electron beam semiconductor lithography.

However, the use of cesium as a work function reducer often causes many problems. For example, cesium is very sensitive to oxidizing gases such as water vapor, oxygen, and carbon dioxide. In addition, cesium has a very high vapor pressure, so that it is difficult to control in the system. Furthermore, electron stimulated desorption (ESD) occurs since electrons emitted from the surface induce desorption of cesium, especially from slightly oxidized surfaces.

Accordingly, there is a demand to develop a precise and reliable cesium vapor emitter for the above-described industries.

### SUMMARY OF THE INVENTION

Accordingly, the present invention is directed to an apparatus and method for emitting cesium vapor that substantially obviates one or more of problems due to limitations and disadvantages of the related art.

An object of the present invention is to provide an apparatus and method for emitting cesium vapor that provides a precise and reliable delivery of the cesium vapor in the various applications.

Additional features and advantages of the invention will be set forth in the description that follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a cesium vapor emitter comprises a housing having at least one chamber in fluid communication with at least one outlet, at least one reservoir containing cesium disposed within each chamber, the reservoir having a filter disposed between the cesium and the outlet, a heating element that controls the temperature of the reservoir, and a stopper securing the reservoir in the chamber.

In another aspect of the present invention, a method for emitting cesium vapor comprises providing a housing including at least one chamber in fluid communication with at least one outlet, inserting at least one reservoir containing cesium in each chamber, sealing the reservoir in the chamber, controlling the temperature of the reservoir, and regulating the flow of cesium through the outlet using a filter disposed between the cesium and the outlet.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a cross-sectional view of a negative ion sputter system using an annular ring type cesium vapor emitter according to a preferred embodiment of the invention.

FIGS. 1A and 1B are a cross-sectional and perspective view, respectively, of the cesium vapor emitter from FIG. 1.

FIG. 2 is an expanded perspective view of an annular ring type cesium vapor emitter according to a preferred embodiment of the invention.

FIG. 3 is a cross-sectional view of a chamber of the cesium vapor emitter shown in FIG. 2.

FIGS. 4A-D are various cross-sectional views of cesium reservoirs according to a preferred embodiment of the invention.

FIGS. 5A and 5B are cross-sectional views of cesium reservoirs having features that prevent the formation of oxide layer in a cesium source before use of a cesium vapor emitter.

FIG. 6 is a breakaway view of an annular ring type cesium emitter according to another preferred embodiment of the invention.

FIG. 7 is a schematic view illustrating a negative ion sputter system using a dual strip type cesium vapor emitter according to another embodiment of the present invention.

FIG. 8 is an expanded perspective view of the dual strip type cesium vapor emitter of FIG. 7.

FIG. 9 is an expanded perspective view of an alternate dual strip type cesium vapor emitter of FIG. 7.

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

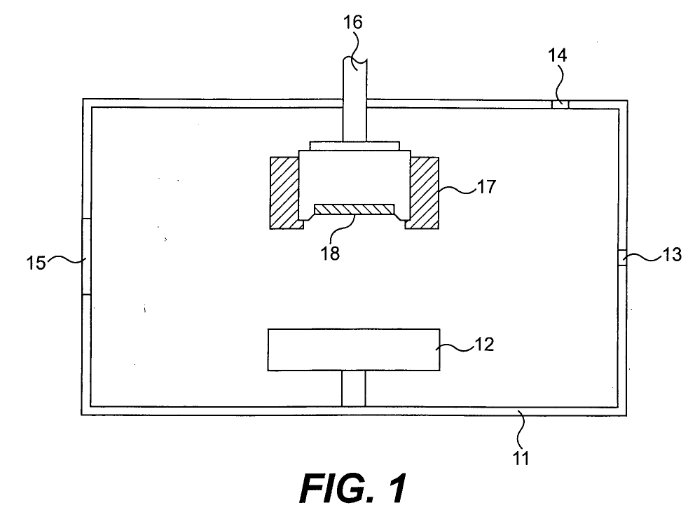

FIG. 1 schematically illustrates a negative ion sputter system having a cesium vapor emitter according to a first embodiment of the present invention. The negative ion sputter system is enclosed by a vacuum chamber 11. A pumping port 13 and a gas outlet port 14 maintain the sputter system under a desired vacuum condition. A substrate 12, where a thin film is deposited using the negative ion sputter cathode, is located in the sputter system and loaded through a loading port 15.

A sputter cathode 16 is placed in the system to face the substrate 12. The substrate 12 and the sputter cathode 16 are spaced apart from each other by a desirable distance for a desired thin film deposition process, as would be readily understood by a person having ordinary skill in the art. FIG. 1A shows that a cesium vapor emitter 17 surrounds the sputter cathode 16 to provide cesium vapor in close proximity to the reacting surface of the sputter target 18. FIG. 1B shows that the cesium vapor emitter has a nozzle 19 including a plurality of outlets 25, in fluid communication with chamber 24, for introducing cesium vapor onto the sputter cathode 16. Multiple chambers (which also may be known as IonCells) are inserted inside the cesium vapor emitter. A typical length for the chamber is about 3 inches. Thus, the number of chambers inside the cesium vapor emitter is dependent upon the length of the emitter. The nozzle 19 can be adapted to a shape that provides a desired emission of cesium vapor. Preferred nozzle shapes may be, for example, a solid stream nozzle, a hollow cone nozzle, a full cone nozzle, or a flat spray nozzle.

The cesium vapor emitter 17 may be located close enough to the target 18 in order to provide substantially pure cesium vapor onto the reacting surface of the sputter target. As previously mentioned, the presence of cesium on the target surface enhances the population of electrons at the surface since cesium reduces the work function of the surface. As a result, negatively charged ions are produced from the sputter target 18 in a sputtering process.

An inert gas supplier (not shown) also may be provided in close proximity to the cesium vapor emitter 17 for supplying an inert gas such as argon, for example, thereby creating a laminar flow through the cesium vapor emitter 17 and across the sputter target 18. Accordingly, the inert gas supplier prevents oxygen and other gases from entering the cesium vapor emitter 17.

In FIG. 1, the cesium vapor emitter has an annular ring shape to match the shape of the sputter cathode 16 and the substrate 12. However, many kinds of shapes may be implemented depending upon the shapes of the sputter cathode and the substrate. For example, a rectangular shape and a dual strip shape may also be used for the purpose of facilitating contact between the emitted cesium vapor and the sputter target 18.

The cesium vapor emitter 17 also may be located outside of a vacuum chamber by using an alternative cesium delivery system, such as delivery tubing, as long as the delivery system is kept in an isothermal condition.

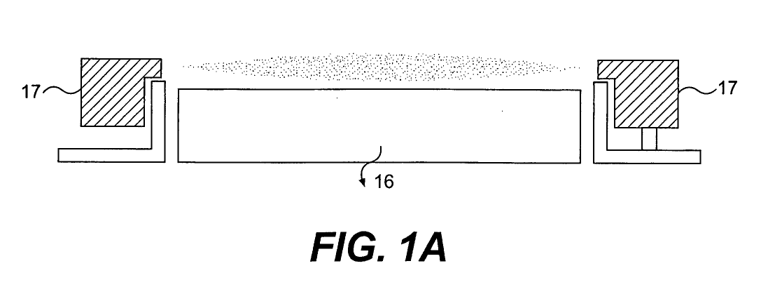

FIG. 2 is an expanded perspective view of the annular cesium vapor emitter 17 of FIG. 1. In FIG. 2, the cesium vapor emitter 17 includes a housing 21 having one or more chambers 24 and one or more cesium reservoirs 20 placed into each chamber.

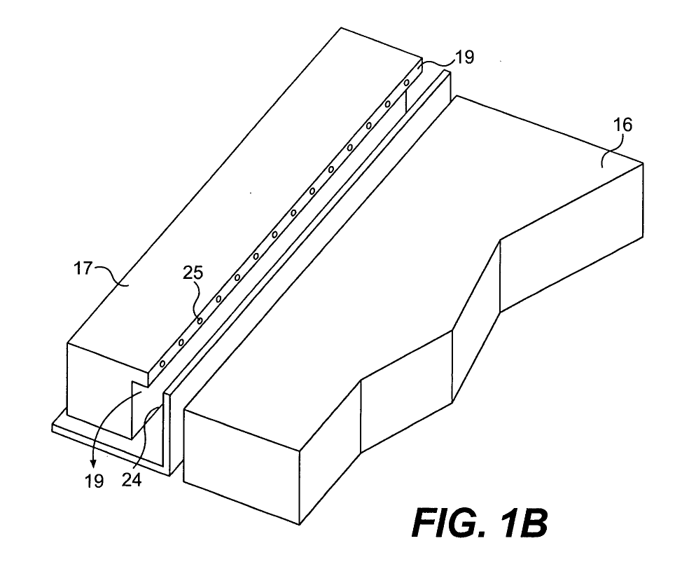

FIG. 3 is a cross-sectional view illustrating a cesium reservoir 20 disposed within a chamber 24. Each chamber 24 has a nozzle 19 having one or more outlets 25 at the side closest to the reacting surface of the sputter target 18 (not shown in FIG. 3). A stopper 26 secures the cesium reservoirs 20 placed into each chamber 24. If an inert gas supplier is present, its outlet will be placed in close proximity to the reservoir 20. The chamber 24 includes a heater 27 and also may include a cooling device (not shown) for precise temperature control of both chamber 24 and cesium reservoir 20.

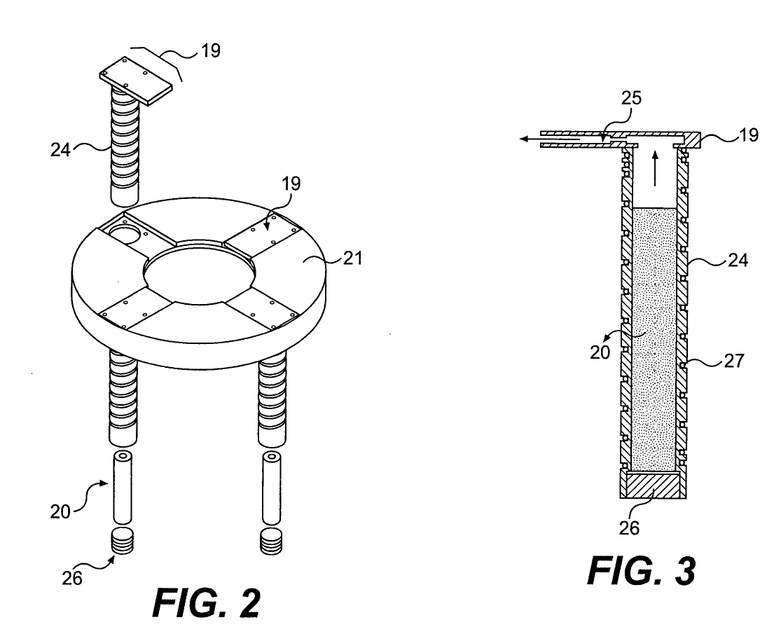

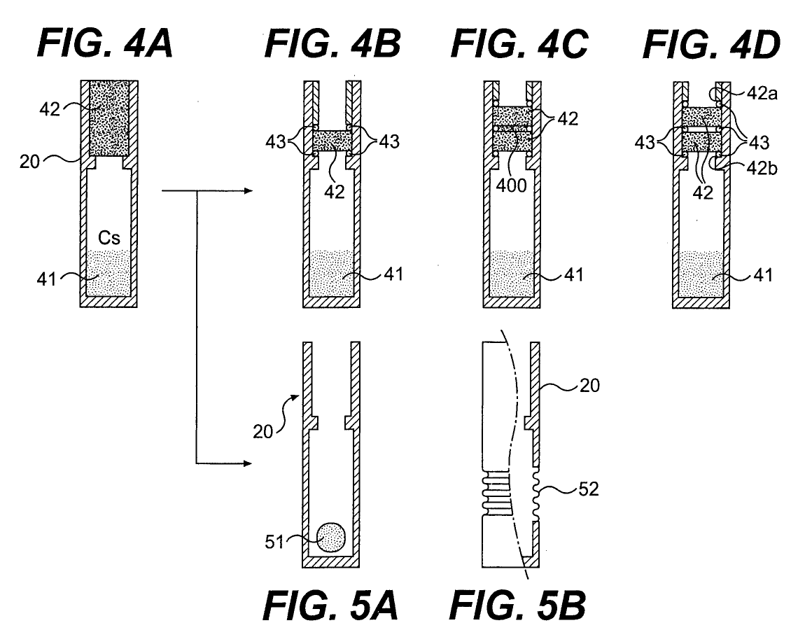

Cesium reservoir 20 is more fully discussed in FIGS. 4A-5B. The cesium reservoir is filled with a cesium source 41. The cesium source 41 can be pure liquid cesium or a cesium slurry. Preferred materials to mix with cesium to make a slurry include: cesium mordenite, glass powder, quartz powder, Al₂O₃, SiO₂, graphite, or any other suitable inert powder. Further, liquid cesium may be packed with an inert material, such as glass or metal wool, to provide cesium source 41 in reservoir 20.

FIGS. 4A-4D illustrate cross-sectional views of various filter arrangements for the reservoir 20 of the present invention. As shown in FIG. 4A, the open-end of reservoir 20 has a filter or plug 42 that is disposed between the cesium source 41 and the outlet 25 of chamber 24. A cesium pellet may be used for the plug 42. The cesium pellet may be fabricated from cesium-mordenite powder by sintering. The cesium pellet prevents an excessive cesium vapor emission from the cesium source 41, so that only a desired amount of the cesium vapor is emitted through the pellet. This is because the pellet has a porous structure. Alternatively, the plug 42 may be formed of a ceramic material such as Zeolite™, for example.

Further, the plug 42 also may be any porous metal or metal mesh, as well as an occluding member with a machined slit or hole. The reservoir also may have a valve (not shown) with an on-off function to regulate cesium vapor emission from reservoir 20. In addition, cesium reservoir 20 may have an internal heater (not shown) for precise temperature control.

Cesium reservoir 20 may also include at least one sealing member 43 engaging the filter 42. FIGS. 4B-4D illustrate a number of arrangements to use sealing members 43 with filter 42 to provide sealing. The sealing member 43 can be an elastomer O-ring, a metal gasket, or any other equivalent structure that is known in the art.

FIG. 4B shows an arrangement wherein a reservoir 20 has single plug 42 with sealing members 43 engaging both the lower (i.e. toward cesium source 41) and upper (i.e. toward the open-end of reservoir 20) surfaces of plug 42. Reservoir 20 also may have upper and lower sealing surfaces 42a, 42b, which engage a sealing member 43 to provide adequate sealing of reservoir 20. FIG. 4C shows a reservoir 20 having two plugs 42, wherein a sealing member 43 engages the upper surface of the upper plug and a sealing member 43 engages the lower surface of the lower plug. A space 400 between the two plugs can be filled with cesium mordenite powder. FIG. 4D shows a reservoir 20 similar to the one illustrated in FIG. 4C, but an additional sealing member 43 is disposed between plugs 42. The number of plugs 42 and sealing members 43 may vary based on a number of variables, including the cesium source 41 used and the amount of cesium vapor emission desired, and is understood by those persons having ordinary skill in the art.

FIGS. 5A and 5B illustrate features of the reservoir that prevent oxidation of cesium source 41. Cesium oxidizes easily when exposed to the atmosphere, and an oxide layer may form in the cesium source 41. As shown in FIG. 5A, a ball 51 can be installed in reservoir 20. Ball 51 can be used to crack an oxidized cesium layer that may form in cesium source 41 before use of cesium vapor emitter 17. Ball 51 can be formed from metal, ceramics, or any material suitable for cracking an oxidized cesium layer.

Also, in order to prevent oxidation, cesium source 41 can be placed inside an ampoule (not shown) made of an inert material, such as glass, when inserted into cesium reservoir 20. This requires that the ampoule be broken so that cesium vapor may be emitted from reservoir 20. By providing bellows 52 disposed thereon, as shown in FIG. 5B, cesium reservoir 20 may be bent so that the ampoule will break and release cesium source 41.

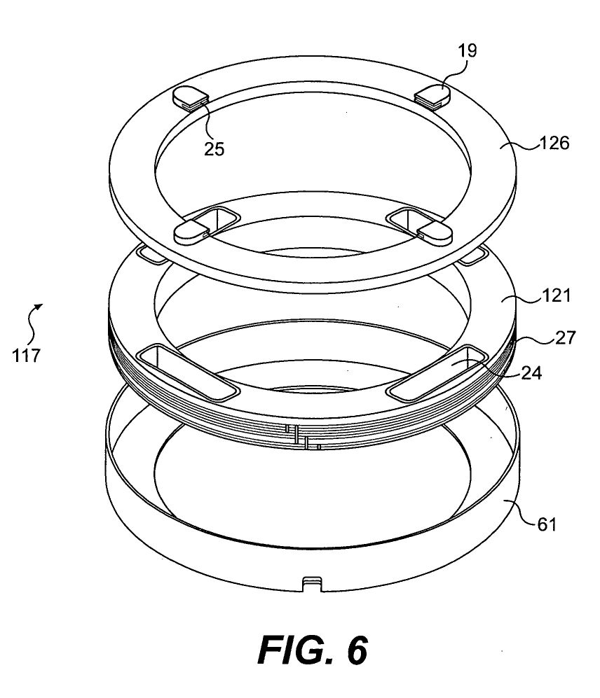

FIG. 6 illustrates an annular cesium vapor emitter according to another preferred embodiment of the invention. Cesium vapor emitter 117 includes a lower housing 61, a main housing 121, and an upper housing or stopper 126. Lower housing 61 supports main housing 121 and stopper 126. Stopper 126 includes at least one outlet 25, and main housing 121 includes at least one chamber 24 for receiving at least one cesium reservoir 20. When stopper 126 engages main housing 121, each chamber 24 is in fluid communication with a respective nozzle 19 so that when one or more cesium reservoirs 20 are inserted in chamber 24, cesium vapor is capable of being emitted through outlets 25. A heater 27 is wrapped at the outside groove of the chamber 24.

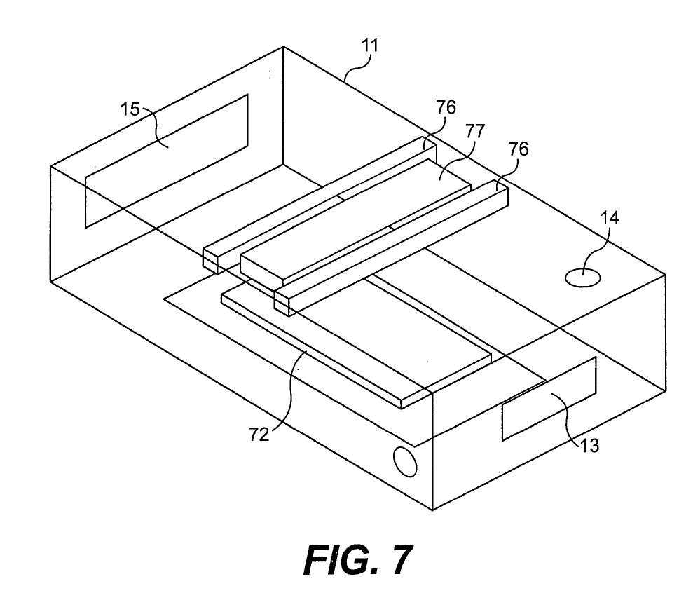

FIG. 7 is a schematic view illustrating a negative ion sputter system using a dual strip type cesium vapor emitter according to another preferred embodiment of the present invention. As noted above, the shape of the cesium vapor emitter may adapted to match the shape of the sputter cathode. The dual strip type cesium vapor emitter of the present invention may be applicable to treat a large sized rectangular substrate, such as a glass substrate for a liquid crystal display panel or a plasma display panel.

As shown in FIG. 7, a rectangular shaped substrate 72 is placed in the negative ion sputter system. For a better efficiency in sputtering, a sputter cathode 77 may have to match the shape of the substrate 72. Also, a dual strip type cesium vapor emitter 76 may provide a better efficiency in introducing cesium vapor onto the reacting surface of the sputter cathode 77 by matching the shape of the sputter cathode 77. Other elements are similar to those of the preferred embodiment illustrated in FIG. 1, except for the shapes of the sputter cathode 77 and the cesium vapor emitter 76. Accordingly, detailed descriptions for the other elements will be omitted for simplicity.

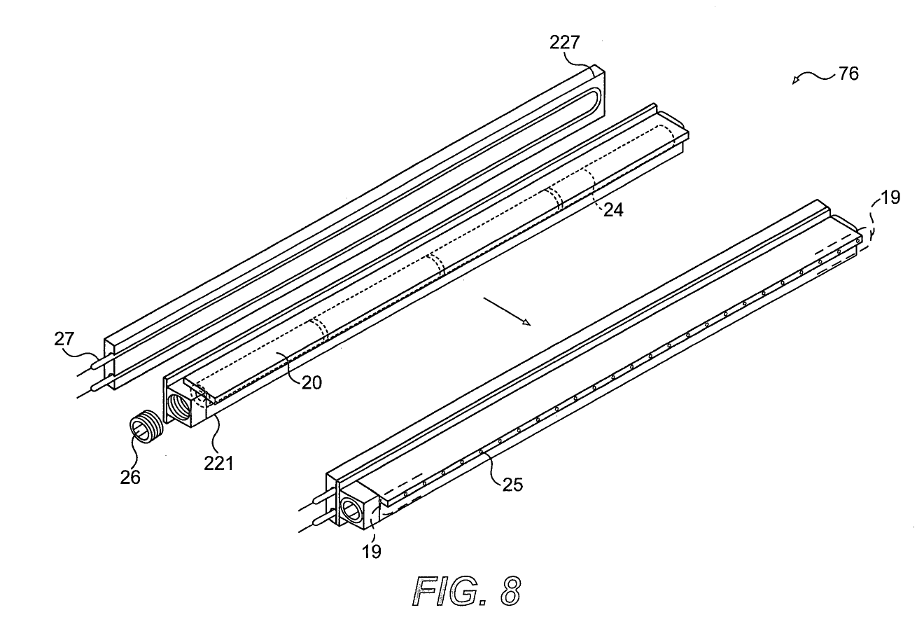

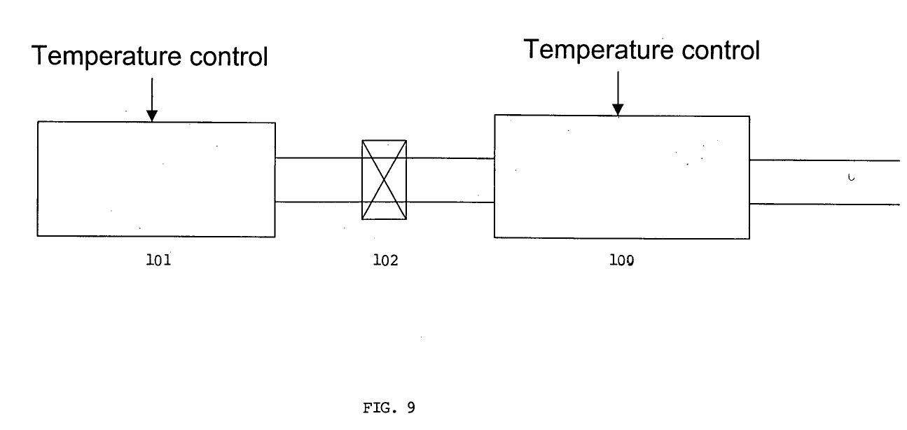

FIGS. 8 and 9 are expanded perspective views of the dual strip type cesium vapor emitter 76 of FIGS. 7. As shown in FIG. 8, one of the dual strip type cesium vapor emitter 76 includes a heater portion 227 having a heater 27 and a main housing 221 having a chamber 24. Main housing 221 also includes a nozzle 19 having one or more outlets 25 in fluid communication with chamber 24. One or more cesium reservoirs 20 are located in the chamber 24. Cesium vapor is introduced onto the reacting surface via the outlets 25 in nozzle 19 of the rectangular sputter cathode 77 (shown in FIG. 7). Accordingly, by the use of cesium vapor on the sputter cathode, a high yield of negatively charged ions is produced from the sputter cathode.

A method according to a preferred embodiment of the present invention will now be described referring the annular ring type emitter described in FIGS. 2-5B. A cesium reservoir 20 is placed into a chamber 24 of housing 21. A stopper 26 is used to tightly seal the cesium reservoir 20 so that the cesium vapor is emitted from outlet 25 only. The stopper 26 may be formed of the same material as the housing 21. For example, a chemically inert material such as stainless steel may be appropriate for the purpose of the present invention. Due to this structure, the cesium reservoir 20 can be readily replaced with a newly refilled reservoir if necessary.

The temperatures of the chamber 24 and cesium reservoir 20 are controlled using at least a heater 27. A cooling device may also be used for more precise temperature control. The flow of cesium vapor emitting from the cesium source 41 is controlled by a filter 42 at the open end of reservoir 20. A valve (not shown) with an on-off function may also be used to regulate the flow of cesium vapor emitted from chamber 24. Cesium vapor is introduced onto the reacting surface of the sputter target 18 through outlets 25 in fluid communication with chamber 24. There are no critical limitations in the size or number of outlets. As long as a desired amount of cesium vapor is provided to the sputter target 18, any dimensions are acceptable in the present invention.

Although a negative ion sputter system is exemplified in the present invention, the cesium vapor emitter of the present invention may be applicable to other applications such as an electron tube for a display or camera tube, an electro-lithographic application, an electron microscopy, or any other photoelectron generator such as mass spectrometry and electron beam semiconductor lithography.

It will be apparent to those skilled in the art that various modifications and variations can be made in the cesium vapor emitter and the method of fabricating the same of the present invention without departing from the spirit or scope of the inventions. Thus, it is intended that the present invention covers the modifications and variations of this invention provided they come within the scope of the appended claims and their equivalents.

What is claimed is:

1. A cesium vapor emitter, comprising:
a housing including at least one chamber in fluid communication with at least one outlet;
at least one reservoir containing cesium disposed within the at least one chamber, said reservoir having a filter between the cesium and the outlet;
a heating element that controls the temperature of the reservoir; and
a stopper securing the at least one reservoir within the chamber.

2. The cesium vapor emitter according to claim 1, wherein the filter comprises a porous metal.

3. The cesium vapor emitter according to claim 1, wherein the filter comprises a metal mesh.

4. The cesium vapor emitter according to claim 1, wherein the filter comprises a machined aperture.

5. The cesium vapor emitter according to claim 1, wherein the filter comprises a sintered ceramic composition.

6. The cesium vapor emitter according to claim 5, wherein the sintered ceramic composition comprises cesium mordenite.

7. The cesium vapor emitter according to claim 1, further comprising a sealing member engaging the filter, wherein the sealing member is disposed between the cesium and a plug.

8. The cesium vapor emitter according to claim 10, wherein the sealing member comprises elastomer.

9. The cesium vapor emitter according to claim 10, wherein the sealing member comprises metal.

10. The cesium vapor emitter according to claim 1, further comprising a cracking member within the reservoir.

11. The cesium vapor emitter according to claim 7, wherein the cracking member comprises metal.

12. The cesium vapor emitter according to claim 7, wherein the cracking member comprises ceramic.

13. The cesium vapor emitter according to claim 1, wherein the cesium is mixed with an inert substance to form a cesium slurry.

14. The cesium vapor emitter according to claim 13, wherein the cesium slurry comprises cesium mordenite.

15. The cesium vapor emitter according to claim 13, wherein the cesium slurry comprises glass powder.

16. The cesium vapor emitter according to claim 13, wherein the cesium slurry comprises quartz powder.

17. The cesium vapor emitter according to claim 13, wherein the cesium slurry comprises Al₂O₃.

18. The cesium vapor emitter according to claim 13, wherein the cesium slurry comprises SiO₂.

19. The cesium vapor emitter according to claim 13, wherein the cesium slurry comprises graphite.

20. The cesium vapor emitter according to claim 13, wherein the cesium slurry comprises glass wool.

21. The cesium vapor emitter according to claim 13, wherein the cesium slurry comprises metal wool.

22. The cesium vapor emitter according to claim 1, wherein the reservoir comprises bellows.

23. The cesium vapor emitter according to claim 22, wherein the cesium is disposed within an ampoule.

24. The cesium vapor emitter according to claim 1, further comprising a valve regulating the flow of cesium vapor through the outlet.

25. The cesium vapor emitter according to claim 1, wherein the outlet is designed in a nozzle shape producing a desired injection of cesium vapor.

26. The cesium vapor emitter according to claim 25, wherein the nozzle shape comprises a solid stream nozzle.

27. The cesium vapor emitter according to claim 25, wherein the nozzle shape comprises a hollow cone nozzle.

28. The cesium vapor emitter according to claim 25, wherein the nozzle shape comprises a full cone nozzle.

29. The cesium vapor emitter according to claim 25, wherein the nozzle shape comprises a flat spray nozzle.

30. The cesium vapor emitter according to claim 1, further comprising a cooling element.

31. The cesium vapor emitter according to claim 1, further comprising a delivery tube in fluid communication with the outlet.

32. A method for emitting cesium vapor, the method comprising the steps of:
providing a housing including at least one chamber in fluid communication with at least one outlet;
inserting at least one reservoir containing cesium in the at least one chamber;
sealing the at least one reservoir in the chamber;
controlling the temperature of the reservoir; and
regulating the flow of cesium through the outlet using a filter disposed between the cesium and the outlet.

33. The method according to claim 32, further comprising the step of regulating the flow of cesium through the outlet using a valve.

34. The method according to claim 32, further comprising the step of inhibiting the formation of an oxide layer of cesium before use.

35. The method according to claim 34, wherein the step of inhibiting the formation of an oxide layer of Cesium comprises installing a cracking member in the reservoir.

36. The method according to claim 32, wherein the step of inserting at least one reservoir comprises mixing the cesium with an inert substance to form a cesium slurry.

37. The method according to claim 36, wherein the cesium slurry comprises cesium mordenite.

38. The method according to claim 36, wherein the cesium slurry comprises glass powder.

39. The method according to claim 36, wherein the cesium slurry comprises quartz powder.

40. The method according to claim 36, wherein the cesium slurry comprises Al₂O₃.

41. The method according to claim 36, wherein the cesium slurry comprises SiO₂.

42. The method according to claim 36, wherein the cesium slurry comprises graphite.

43. The method according to claim 36, wherein the cesium slurry comprises glass wool.

44. The method according to claim 36, wherein the cesium slurry comprises metal wool.

45. The method according to claim 32, wherein the step of inserting the at least one reservoir comprises cesium being disposed within an ampoule.

46. The method according to claim 45, further comprising the step of breaking the ampoule.

47. The method according to claim 46, wherein the step of providing the at least one reservoir comprises providing bellows on said at least one reservoir that permit breaking of the ampoule.

48. The method according to claim 32, wherein the step of controlling the temperature of the reservoir comprises providing a heating element.

49. The method according to claim 32, wherein the step of controlling the temperature of the reservoir comprises providing a cooling element.

50. The method according to claim 32, wherein the step of controlling the temperature of the reservoir is within a range of about 0° to 400° C.

51. The method according to claim 32, further comprising the step of forming the outlet in the shape of a nozzle for a desired injection of cesium vapor.

52. The method according to claim 51, wherein the outlet is formed in the shape of a solid stream nozzle.

53. The method according to claim 51, wherein the outlet is formed in the shape of a hollow cone nozzle.

54. The method according to claim 51, wherein the outlet is formed in the shape of a full cone nozzle.

55. The method according to claim 51, wherein the outlet is formed in the shape of a flat spray nozzle.

56. The method according to claim 32, further comprising the steps of:
installing the housing outside of the vacuum chamber; providing a delivery tube in fluid communication with the at least one outlet; and
controlling the temperature of the delivery tube such that the cesium vapor is substantially isothermal while passing from the at least one outlet through said delivery tube.

57. The method according to claim 32, further comprising the step of locating the at least one outlet at a distance from a target such that the cesium vapor emitted toward said target is substantially pure.

58. An apparatus for emitting cesium vapor, comprising:
a cesium vapor emitter located outside a vacuum chamber;
a housing including at least one chamber having a delivery tube in fluid communication with at least one outlet;
at least one reservoir containing cesium disposed within the at least one chamber, said reservoir having a filter between the cesium and the outlet;
a heating element that controls the temperature of the reservoir; and
a stopper securing the at least one reservoir within the chamber.
